(19) United States
(12) Patent Application Publication
(10) Pub. No.: US 2023/0042345 A1
(43) Pub. Date: Feb. 9, 2023

(54) COMPLIANCE ENGINE

(71) Applicant: Ethena, Inc., Brooklyn, NY (US)

(72) Inventors: Anne Solmssen, New York, NY (US); Matthew Dean, Brooklyn, NY (US); Dillen Roggensinger, Boulder, CO (US)

(21) Appl. No.: 17/394,267

(22) Filed: Aug. 4, 2021

(51) Int. Cl. G06Q 50/20; G06Q 10/06; G06Q 10/10; G06Q 30/00

(52) U.S. Cl. CPC G06Q 50/2057; G06Q 10/063114; G06Q 10/109; G06Q 10/105; G06Q 30/018

(57) ABSTRACT

Various aspects of the subject technology relate to systems, methods, and machine-readable media for compliance training. The method includes determining a compliance status of a user. The method also includes determining a curriculum for the user based at least in part on the determined compliance status of the user, the curriculum comprising a series of nudges. The method also includes setting a deadline for completion of the curriculum. The method also includes sending the user reminders regarding completion of the curriculum. The method also includes receiving confirmation of completion of the curriculum. The method also includes generating a compliance certificate for the user.

### TECHNICAL FIELD

The present disclosure generally relates to compliance training, and more particularly to ensuring completion of compliance training.

### BACKGROUND

State and federal laws require and enforce compliance training for a variety of industries. Conventionally, compliance training includes employee training that is mandated by legislation, regulation, or policy. For example, compliance training is for educating employees on the state and federal laws or regulations applicable to their job function or industry. Conventionally, such laws are put in place to maintain employee safety in the workplace and to prevent undesirable conduct such as harassment.

### BRIEF SUMMARY

The subject disclosure provides for systems and methods for compliance training. In an aspect, a compliance engine automatically provides compliance training incrementally over a period of time, while also meeting state and federal mandates. For example, the compliance training may be broken down into several nudges (e.g., three sessions lasting 20 minutes or less, for a total of one hour), which improves learning and retention of information for users.

According to one embodiment of the present disclosure, a computer-implemented method for compliance training is provided. The method includes determining a compliance status of a user. The method also includes determining a curriculum for the user based at least in part on the determined compliance status of the user, the curriculum comprising a series of nudges. The method also includes setting a deadline for completion of the curriculum. The method also includes sending the user reminders regarding completion of the curriculum. The method also includes receiving confirmation of completion of the curriculum. The method also includes generating a compliance certificate for the user.

According to one embodiment of the present disclosure, a system is provided including a processor and a memory comprising instructions stored thereon, which when executed by the processor, causes the processor to perform a method for compliance training. The method includes determining a compliance status of a user. The method also includes determining a curriculum for the user based at least in part on the determined compliance status of the user, the curriculum comprising a series of nudges. The method also includes setting a deadline for completion of the curriculum. The method also includes sending the user reminders regarding completion of the curriculum. The method also includes receiving confirmation of completion of the curriculum. The method also includes generating a compliance certificate for the user.

According to one embodiment of the present disclosure, a non-transitory computer-readable storage medium is provided including instructions (e.g., stored sequences of instructions) that, when executed by a processor, cause the processor to perform a method for compliance training. The method includes determining a compliance status of a user. The method also includes determining a curriculum for the user based at least in part on the determined compliance status of the user, the curriculum comprising a series of nudges. The method also includes setting a deadline for completion of the curriculum. The method also includes sending the user reminders regarding completion of the curriculum. The method also includes receiving confirmation of completion of the curriculum. The method also includes generating a compliance certificate for the user.

According to one embodiment of the present disclosure, a system is provided that includes means for storing instructions, and means for executing the stored instructions that, when executed by the means, cause the means to perform a method for compliance training. The method includes determining a compliance status of a user. The method also includes determining a curriculum for the user based at least in part on the determined compliance status of the user, the curriculum comprising a series of nudges. The method also includes setting a deadline for completion of the curriculum. The method also includes sending the user reminders regarding completion of the curriculum. The method also includes receiving confirmation of completion of the curriculum. The method also includes generating a compliance certificate for the user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A-1D illustrate exemplary timelines for compliance training, according to certain aspects of the present disclosure.

FIGS. 2A-2D illustrate exemplary user interfaces for compliance training, according to certain aspects of the present disclosure.

FIG. 3 illustrates a system configured for compliance training, in accordance with one or more implementations.

FIG. 4 illustrates an example flow diagram for compliance training, according to certain aspects of the present disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

State and federal laws require and enforce compliance training for a variety of industries. Conventionally, compliance training includes employee training that is mandated by legislation, regulation, or policy. For example, compliance training is for educating employees on the state and federal laws or regulations applicable to their job function or industry. Conventionally, such laws are put in place to maintain employee safety in the workplace and to prevent undesirable conduct such as harassment.

Compliance training may be encouraged and enforced from two directions. One direction is state and federal laws, such as harassment prevention in some states, Occupational Safety and Health Administration (OSHA) regulations, Health Insurance Portability and Accountability Act (HIPAA) provisions, etc. Using harassment prevention as an example, states tend to formulate the requirement as follows: “You must train your team members every X years on ABC topics and you have Y months after they start to do so.”

The other direction is general risk mitigation pressure, such as anti-bribery or anti-money laundering training, etc. For example, in a situation where an employer is sued because of an employee acting inappropriately, the employer would need to be able to prove in a court of law that they took reasonable measures to train their employees. In such cases, the above formulation may still make sense here, but the values for X and ABC may be governed instead by experience or case law.

Conventionally such compliance training may be completed in a single day by watching hour long videos. However, it is unlikely that an employee would remember the details of any of the topics mentioned above (e.g., many of which may be essential to day-to-day work), especially a year later after the training was completed. Additionally, the employee may experience/undergo changes in their status/location as time moves on, which may require more and/or different compliance training. For example, the employee may move to a different state, be promoted to become a manager, join a different department, etc.

Therefore, there is a need for commercially available compliance training to aid employers in allowing their employees to complete their training requirements that overcomes the shortcomings described above. According to aspects, the training content may be spread out over a period of time while still meeting the required regulatory standards, as well as taking into account the constant changes an employee may undergo. This is because training over time is better than all at once, as it improves learning and retention of information.

The subject disclosure provides for systems and methods for compliance training. In an aspect, a compliance engine automatically provides compliance training incrementally over a period of time, while also meeting state and federal mandates. For example, the compliance training may be broken down into several nudges (e.g., three sessions lasting 20 minutes or less, for a total of one hour), which improves learning and retention of information for users.

The disclosed system addresses a problem in traditional compliance training tied to computer technology, namely, the technical problem of ensuring compliance with state and federal training mandates. The disclosed system solves this technical problem by providing a solution also rooted in computer technology, namely, by automatically providing compliance training incrementally over a period of time prior to a compliance deadline. The disclosed system also improves the functioning of the computer itself because it trains the computer to recognize and extract relevant information from a compliance status of each user to tailor compliance training to each user.

According to aspects, a compliance engine may apply training incrementally. For example, the compliance training may occur as a series of nudges, where each nudge includes small bite sized bits of learning on a given topic that are easy to digest for a learner.

According to aspects, there may be three types of nudges: core curriculum, continuous learning, and refresher content. Core curriculum may include core learning required on a subject. It may either be given to a user all at once (e.g., if a company insists that they get trained right away), or more ideally may be spread out over a number of months based on the legal regulations and training deadlines. For example, the core curriculum may be dispensed in three sessions, with each session being 20 minutes long, for a total of one hour.

Continuous learning may occur after a user has achieved compliance. For example, now that the user is compliant, the compliance engine may strive to keep the user compliant through consistent learning over time. According to aspects, the continuous learning may include small incremental nudges that occur monthly (e.g., one or more five-minute training sessions each month). These nudges may include advanced learning, where the compliance engine may relate those topics that were learned in the core curriculum to the news, the particular time of the year, and/or it may bring up some new way to action the learning, etc.

Refresher content may be utilized to refresh training for users. Every so often, a user may need to be re-told the legal basics, and so a longer legal-heavy refresher nudge may be created and assigned on a regular basis ahead of the user's training completion anniversary. This is so that an employer may assert that legal basics have been reiterated as per relevant legal requirements. For example, the refresher content may include one 15 minute nudge every nine months in a state/jurisdiction that requires training every year. Alternatively, in a state/jurisdiction that requires training every two years, the nudges may occur every one year and nine months. As a result, it is understood that the refresher content may vary based on each state/jurisdiction.

According to aspects, the compliance engine may take into account and track changes in a user's status. For example, a user may have already undergone training through the compliance engine for a year. It is possible that in the middle of the year that the user was promoted to become a manager and thus needed more training (or the user may have changed states/jurisdictions, etc.). In such cases, the compliance engine may update its tracking to ensure that the user remains compliant and/or attains compliance (e.g., receive the right training), where necessary. The compliance engine may also provide visibility to an administrator regarding the user's compliance status.

According to aspects, the compliance engine may be configured to perform many functions, including assigning the right people the right training, especially when something about them changes (e.g., they move, become a manager, etc.). This allows administrators to simply “set it and forget it” instead of having to remember and keep track of every change in every employee. The compliance engine may also be configured to report on whether someone is compliant or not, close to being not compliant, etc. The compliance engine may also be configured to clearly communicate to an administrator an up-to-date status of a given employee, and whether or not they are at risk of falling out of compliance. As a result, the compliance engine is able to achieve desirable results in a configurable way, and for any compliance situation.

According to aspects, the compliance engine also provides for personalized learning, which improves training efficacy. For example, a learner may be targeted based on everything that the system knows about them (e.g., user provided information, previous training information, user preferences, etc.). In this way, an engineer at a technology company may receive different training content than a worker at a beverage factory, which increases learning personalization for each user.

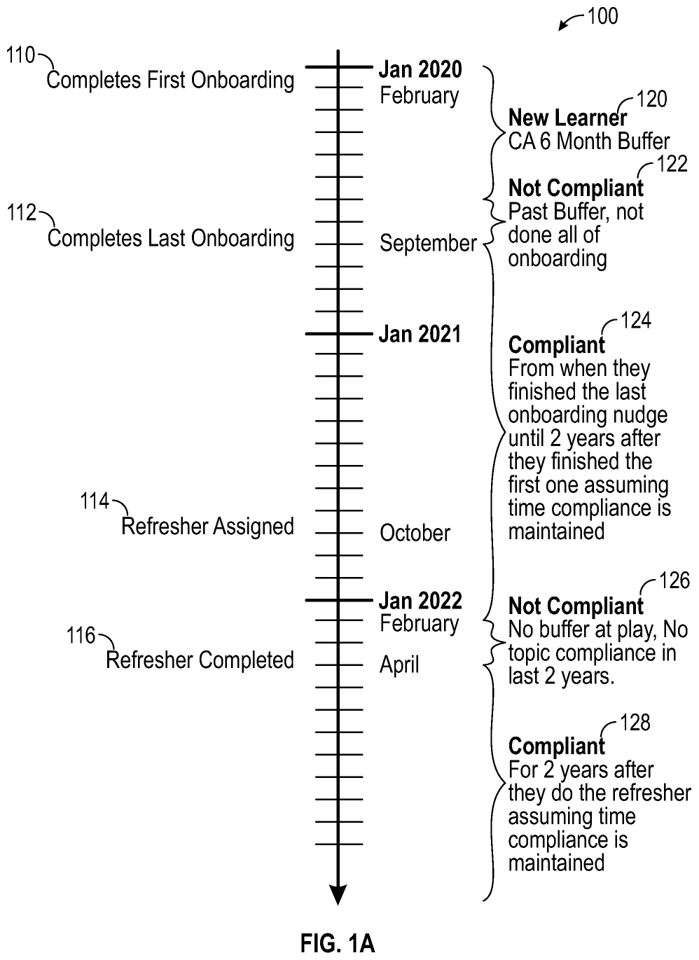

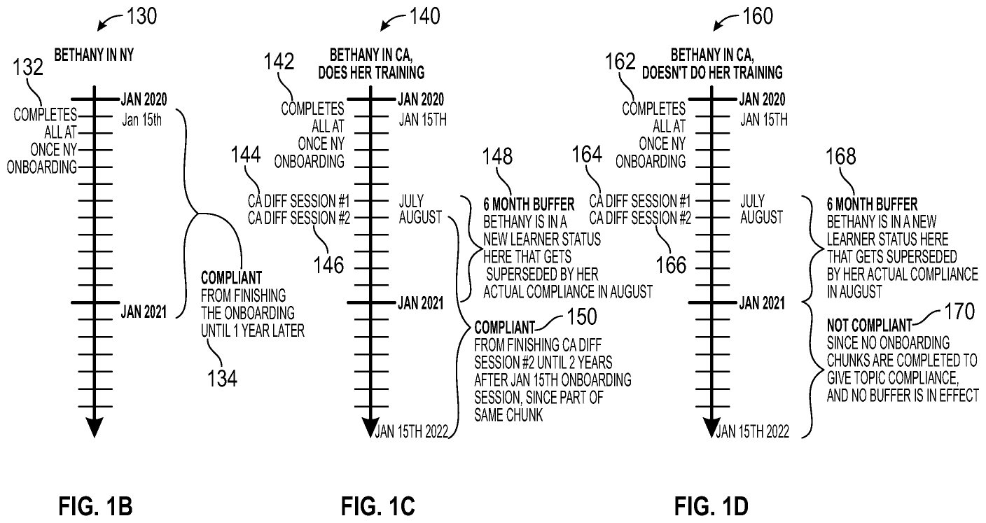

FIGS. 1A-1D illustrate exemplary timelines for compliance training, according to certain aspects of the present disclosure. Referring to FIG. 1A, a timeline 100 illustrates compliance statuses 122, 124, 126, 128 of a user 120 ongoing from January 2020 through January 2022, and beyond. For example, the user 120 may be a new learner that was hired January 2020. The user 120 may have completed their first onboarding 110 in February 2020 and their last onboarding 112 in September 2020. As a new employee, the user 120 has six months under law (e.g., in this case, it may be assumed that the user is in California) to complete their onboarding training. However, because the user 120 completed their onboarding in September 2020, the user 120 was not complaint 122 for two months from July 2020 to August 2020.

Once the user 120 has completed the last onboarding 112, the user 120 may be compliant 124 for two years from the date of completion of the first onboarding 110 (e.g., under California law). Therefore, the user 120 has until February 2022 to complete refresher content. For example, the refresher content may be assigned 114 in October 2022, and completed 116 in April 2022. Because the refresher was completed two months after the two year date of February 2022, the user 120 was not compliant 126 for two months from February 2020 to March 2020. Once the refresher is completed 116, the user 120 is compliant 128 for another two years from that date of completion.

Referring to FIG. 1B, another timeline 130 illustrates a user that completes their training in a first state (e.g., New York) 132 on Jan. 15, 2020. The user is now compliant 134 in New York for a year.

FIGS. 1C and 1D illustrate alternate possibilities on what may occur if the user moves from the first state (e.g., a first jurisdiction) to a second state (e.g., a second jurisdiction). For example, the user may move from New York to California after completing their onboarding training in New York.

Referring to FIG. 1C, a timeline 140 illustrates the user completing their New York onboarding 142 and then moving to California. In California, the user completes a first California session 144 in July 2020 and a second California session 146 in August 2020. Upon completing the first California session 144, the user gets a six month buffer 148 as a new learner in California. This new learner status is superseded by the user completing the second California session 146 in August 2020. The user is now compliant 150 from the date of finishing the second California session 146 to two years from Jan. 15, 2020, which was the date of completion of the New York onboarding 142.

Referring to FIG. 1D, a timeline 160 illustrates the user completing their New York onboarding 162 and then moving to California. In California, the user completes a first California session 164 in July 2020. However, the user does not complete a second California session 166. As a result, the user is not compliant 170 because they are outside of the six month buffer 168.

As illustrated by FIGS. 1A-1D, tracking compliance may become tricky in terms of when users actually did the training versus when they were asked to do it, as well as when things change about a person and how that all plays into compliance.

As described herein, the compliance engine may aid in ensuring timely compliance in all of the above-illustrated situations of FIGS. 1A-1D, and more. According to aspects, the compliance engine may assign the right people the right training. In an implementation, each user (e.g., employee) may be assigned to one of many various tracks of what training is required for each particular user (e.g., broken down by state, region, country, manager status, etc.). Based on the track the user is on, the compliance engine may assign an appropriate core curriculum to each user to ensure compliance. When users change their status, it may be determined if a different track now applies. If so, the users may be assigned the difference in the training tracks so as to always ensure everything is covered.

Additionally, for continuous learning and refresher nudges, individual nudges may be customized per location, manager status, company, etc., so as to allow creation of refresher training specific to the individual (e.g., someone on a factory floor can get a different annual refresher on how to report an issue than someone who works at corporate headquarters).

According to aspects, the compliance engine may take into account various compliance factors for each user including, but not limited to: how long someone's compliance is good for, how many minutes they need to train, how long they have when starting to get compliant, etc. For example, these compliance factors may be stored in a database of values.

According to aspects, each compliance factor may be configurable by: training course, company (e.g., configurable per client), region (e.g., Asia vs. EU), country, state, role (e.g., manager, etc.), and more.

According to aspects, the compliance engine may load information about the relevant laws and standards for each compliance training course. For example, this information may be obtained through consulting with subject matter experts, or the like. For each jurisdiction and role, the following information may be loaded to determine a relevant compliance training course: compliance period, how long the training is valid for (e.g., one year, two years, etc.), onboarding period, how much time to get compliant (e.g., three months, six months, etc.), required minutes, how many minutes of training counts as being compliant, timer percentage, etc.

According to aspects, the compliance engine may block users from finishing each module of training before a designated allotted time. For example, the user may be required to spend five minutes on a given module to be credited with the training. In an implementation, a timer percentage of 50% or more may be determined to be satisfactory where legally permissible. For example, if a user takes 2.5 minutes to complete the five minute training, which is a 50% timer percentage, that may be considered satisfactory and the user will not have to wait until the full five minutes has passed. It is understood that the timer percentage is exemplary, and other timer percentages, greater or less than 50%, may also be determined to be satisfactory.

According to aspects, a completion certificate may be generated and sent to the user when they are compliant in a given course. For example, the completion certificate may state, “You have met all the requirements of the state of California,” or “You have satisfied the standards,” if the user is in a jurisdiction without any specific requirements.

According to aspects, employee data may be loaded into the compliance engine in various ways. For example, small teams may upload their information manually through a software interface, while larger teams may utilize a comma-separated values (CSV) upload. Human resource management system (HRMS) and/or learning management system (LMS) integration may also be supported (e.g., for enterprise clients).

Data that is collected regarding employees may include: name, email, manager status, language (e.g., for localizing), country, state (if in the US), department, etc. This data may be utilized to determine which jurisdiction's standards may be applied for the compliance training.

According to aspects, the compliance training may be configurable based on each user. For example, different users may prefer different methods of learning. Some users may prefer training that is funny/witty (e.g., includes pictures), whereas others may prefer training that is more direct and gets straight to the point (e.g., reading an article). In an implementation, the training content may include multiple versions so that it is configurable by each user based on their individual training preferences.

According to aspects, the compliance engine may load historical training data of employees. Whether a company did in-person training, or if they had a previous training provider, or otherwise, it is important to take those factors into consideration when calculating and considering learners' compliance statuses. For example, an employee may have just completed a two hour in-person training course a month ago. This same employee would be exempt from a full slate of core curriculum to avoid overtraining in that area.

According to aspects, past training may be designated with a nudge that includes an amount of training time completed. The past training may then be utilized to mark a nudge equivalency between this nudge and other nudges in the core curriculum. For example, a 30 minute in-person learning experience completed by a user may be determined to be equivalent to six nudges, topic wise, depending on what was covered topic-wise in that session. As a result, the nudge equivalency prevents assigning repeat content in the future.

According to aspects, training is provided to learners in one of two distinct operations (e.g., operations for compliance training): one of them assigns core curriculum content, and the other assigns continuous learning content. Assigning core curriculum may be performed in the following situations: when a learner is added to the system and/or enrolled in a course, when anything changes about the learner's employment information (e.g., manager status, location, etc.), etc. In an implementation, the system may be configured to zoom in on the context of each learner by pulling information, including, but not limited to, all course information of the learner, the most relevant core curriculum track for the learner for the course based on the learner's employment information, all nudges related to the course and all nudges the learner has completed or been assigned so far, all events related to this learner and course, the most recent computed compliance stats for this learner and course, etc.

According to aspects, the compliance engine may track events related to learners and courses over time such as “you became a manager” or “you started this course” which aid in simplifying determination of a learner's compliance status. In an implementation, compliance statistics may be calculated for each learner/course combo on a regular basis. This includes statistics such as “are you compliant” and “when did that compliance begin/when will it end” and other information, such as scheduling and cadence information, what day of the month the company operates on, whether this learner wants continuous learning quarterly or monthly, did the learner accelerate their onboarding (e.g., instead of having it spread out over 3-5 months, the learner may opt into having it released to them all at once). Additional considerations include whether the company has any monthly overrides. For example, for the month of June, did they want to move their training to a special day of the month because of a company event? Perhaps it is the holidays and they do not want new training being assigned near the end of December.

According to aspects, the compliance engine may consider all the onboarding content currently assigned to a learner and/or completed by the learner in the past. Based on the most recent and relevant onboarding track for this learner, the compliance engine may determine whether there is any additional training this learner needs to perform. For example, if a learner becomes a manager, often there is an additional hour or half hour of training assigned to them. If they move to a state like California with strong requirements, there is usually more content needed as well. Additional considerations include whether the compliance configuration time window is shorter than their previous time window, and whether they need refresher training. For example, if a user moves from California (e.g., with a 2 year window) to New York (e.g., with a 1 year window), the user may actually be behind on their refresher schedule now. This is because the user may be 1.5 years into their training, and so the user may be essentially back-filled from a refresher point-of-view when moving to New York.

According to aspects, a user (e.g., learner) may be assigned new manager or state specific content (e.g., based on a change in user status), but over the course of completing that content in the next three months (e.g., because they are a monthly learner), the user will actually go over their one or two year anniversary and are in need of refresher content. In such situations, the compliance engine may assign the user the refresher content early in anticipation of such an edge case. This would have consequences for the learner, such that with any additional training that needs to be assigned, it may be determined whether to assign it all at once or to spread it out over some number of months. For example, this may be based on the scheduling/cadence information that was pulled. The training program may then be assigned to the user.

According to aspects, it may be decided whether to extend the user's buffer by logging an event for this moment (e.g., events may be how buffers are tracked). For example, when someone gets new training for a valid reason, regulations may be considered that imply some grace period for training (e.g., when a new employee joins, they get 90 days to be trained). It may be assumed this counts for when a user's status changes and new training is needed (e.g., promotion to manager, moved into a new state, etc.).

According to aspects, all new training that is assigned may be associated with a specific event by the individual training modules. For example, a user may be notified that a particular nudge was assigned because they became a manager last month, and that event is also why they have three months to complete the training.

According to aspects, assigning continuous learning may occur on a regular basis for every learner on the compliance engine platform. For example, the assigning may occur at least once a day. In an implementation, the same information as described above may be repeatedly pulled on a daily basis for each learner. This may also include a particular emphasis on a continuous learning cadence of the learner. The continuous learning cadence may be utilized to determine whether a learner prefers their continuous learning every month, every quarter, etc.

According to aspects, a first check is conducted to determine if it is the right day of the month for the given learner and their company. This is because the training occurs over time, as discussed herein. Therefore, time must pass before it is time again to assign the learner their next monthly (or quarterly, etc.) continuous learning program. For example, the compliance engine may check that tomorrow is the right day to assign a continuous learning program because it is a day early for ease of processing notifications to the learners the next day. Now that the right day has been determined, it may be checked (e.g., determined) whether the learner needs refresher content because they are nearing the end of their compliance window.

According to aspects, refresher content may be assigned up to three months before the end of their compliance window. It is understood that this timing is a configurable value, as discussed above. If the learner does not need refresher content, they may be assigned the latest continuous learning content for their course that they have not already completed. It may be assumed that at least one nudge may be assigned each month.

According to aspects, if the user is determined to be a quarterly learner, it may be determined whether they need a few nudges or multiple nudges (e.g., one, two, three nudges, or more). For example, it may be based on how long ago they last were assigned training. This is to avoid edge cases where a user finishes their onboarding, they go onto quarterly training, and given their company's schedule, the first set of quarterly nudges is the next month, instead of naively assigning the user three months of content, which may be overkill. Rather, the user is just assigned for one month, and next quarter the user may be assigned three months of content.

According to aspects, compliance statistics are calculated in a configurable manner. In an implementation, it may first be determined whether a user is compliant. For example, it may be determined by the compliance engine whether in the last compliance period the user has completed their required minutes of training, which includes covering all the required topics in a most relevant onboarding track or most recent refresher nudge. It may then be determined whether there is any action required of the user. In this way, administrators may be notified about whether a user (e.g., learner, employee) needs to be bothered to do their training because they are at risk of falling out of compliance, or have already fallen out of compliance.

According to aspects, it may be determined whether a compliance buffer length is in effect. If so, the user is up-to-date on their training, so no action is required. If the user is within one month of the end of the buffer and have outstanding training (e.g., in the past), action is required. For example, if a user has five sessions of California manager training, and the user completed none of them, the user should be flagged (e.g., a compliance status indicator may turn from green to yellow to red, etc.) after a few months even though they are inside the buffer.

According to aspects, if no buffer is in effect and the user is not currently compliant, it may be determined whether the user has any outstanding training. If they do not have any outstanding training, then no action is required. Otherwise, if the user does have outstanding training, then immediate action is required. If no buffer is in effect and the user is currently compliant and the user has no outstanding training, then no action is required. If the user were to complete no further training but two or fewer months passing is all it takes before they become non-compliant, then action is required. If the learner were to complete no further training, and three or more months are required before they lose compliance, then no action is required.

According to aspects, it may be determined whether a learner is a new learner, a transitioning learner, or a normal learner. For example, if a buffer is in effect because of a course starting event, then the learner is a new learner. If a buffer is in effect because of a location change event or a role change event, then the learner is a transitioning learner. If no buffer is in place, then the learner is a normal learner.

According to additional aspects, the compliance engine may track moments that matter to a user, in addition to delivering training to a learner. For example, the compliance engine may be integrated with a company's applicant tracking system, so that it knows when an employer may be about to interview a candidate in a jurisdiction (e.g., Massachusetts). The compliance engine may send the employer a nudge about special considerations for this interview, such as, “In Massachusetts, you can't ask applicants about their previous salary.”

As another example, an employee is about to travel to China to finalize a deal. The employee may be sent a nudge about special considerations regarding bribery and corruption in China. It is known to the system that the employee is traveling to China because it was detected either through parsing the employee's calendar events and/or based on an integration with a travel management program.

According to aspects, a nudge regarding a moment that matters may be sent based on the above examples. As described above, the compliance engine may be integrated with other systems and may parse language in calendar events. It is understood that this is exemplary only, and other methods may be utilized, including plugging in key phrases that would indicate that a moment that matters (e.g., a significant event) is upcoming (e.g., a business trip happening on a company calendar).

According to additional aspects, computer learning techniques, including artificial intelligence, may be utilized to make the compliance training more effective and personalized. For example, a machine learning algorithm may learn to personalize training for each learner based on at least the above. For example, learning patterns/preferences may be detected for each learner based on a learning history and utilized to customize training for each learner. The machine learning algorithm may also be trained to identify and determine moments that matter as well. For example, natural language processing (NLP) techniques may be utilized.

According to aspects, the machine learning algorithm may personalize training for each learner based on feedback. For example, the machine learning algorithm may determine that a learner has a tendency to prefer nudges that are audio nudges, and so may adjust accordingly to send that the learner audio nudges rather than other types of nudges. In an implementation, neural networks may be utilized to predict which training will work for which people. For example, the neural network may determine a group of similar learners with similar preferences to the learner, and send the learner nudges that the other similar learners prefer.

It is understood that the compliance engine may apply to any population of learners. For example, the population of learners may include desk workers and non-desk workers, in addition to unwired learners (e.g., an unwired population), and others, as well. According to aspects, some learners may complete their training while on the clock so that they are compensated for their time, as opposed to salary workers being allowed to do it anytime. In such cases, the compliance engine may automatically take into account minimum shift staffing needs, and may assign individual learners time throughout the day to do training in a spread out manner so that there are always enough workers (e.g., cashiers, clerks, etc.) available to help customers.

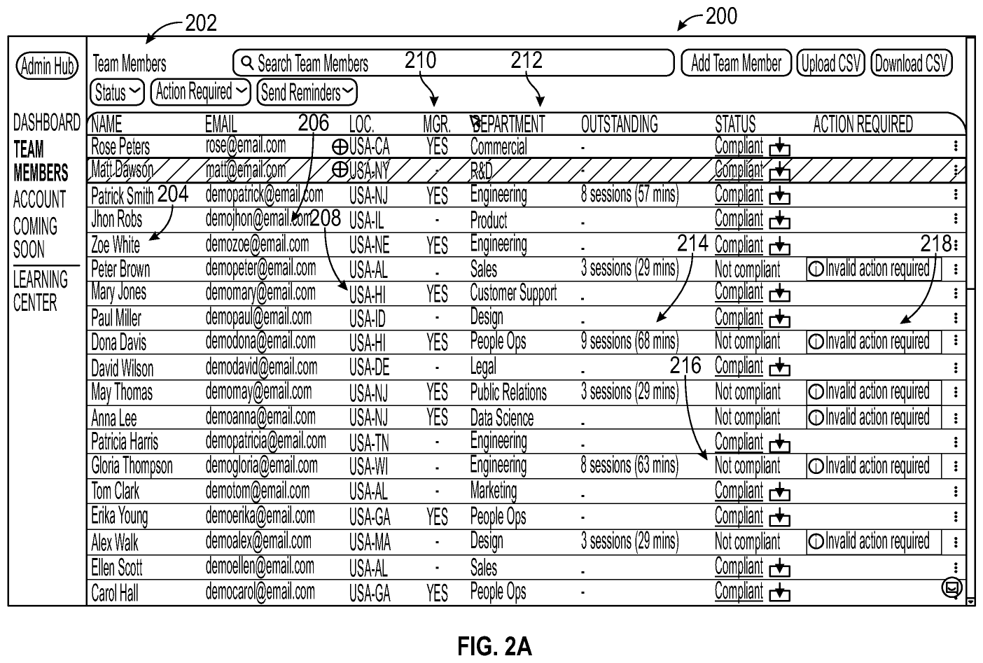

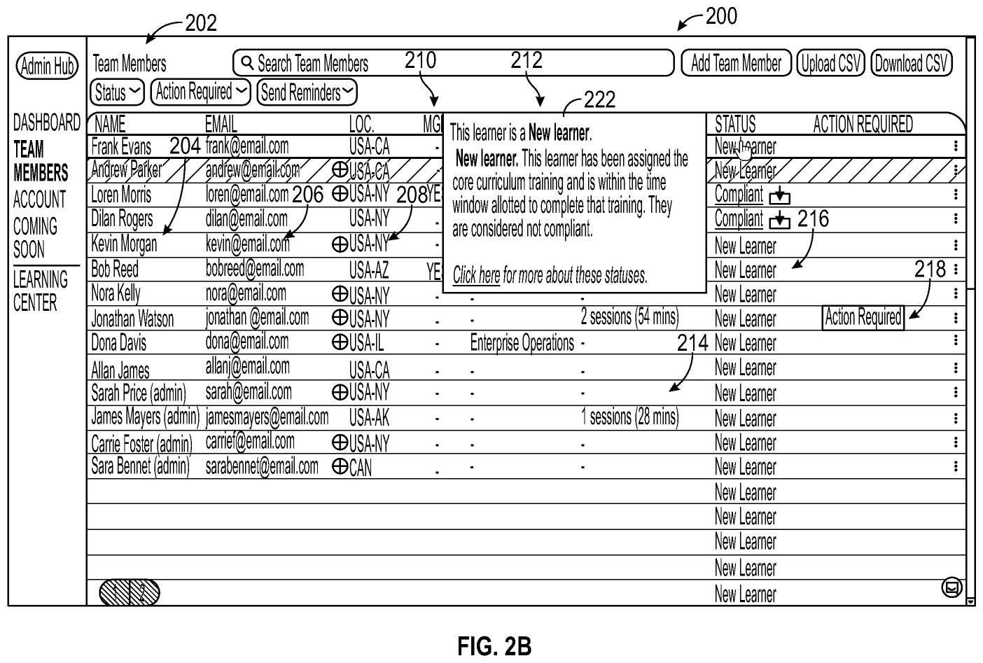

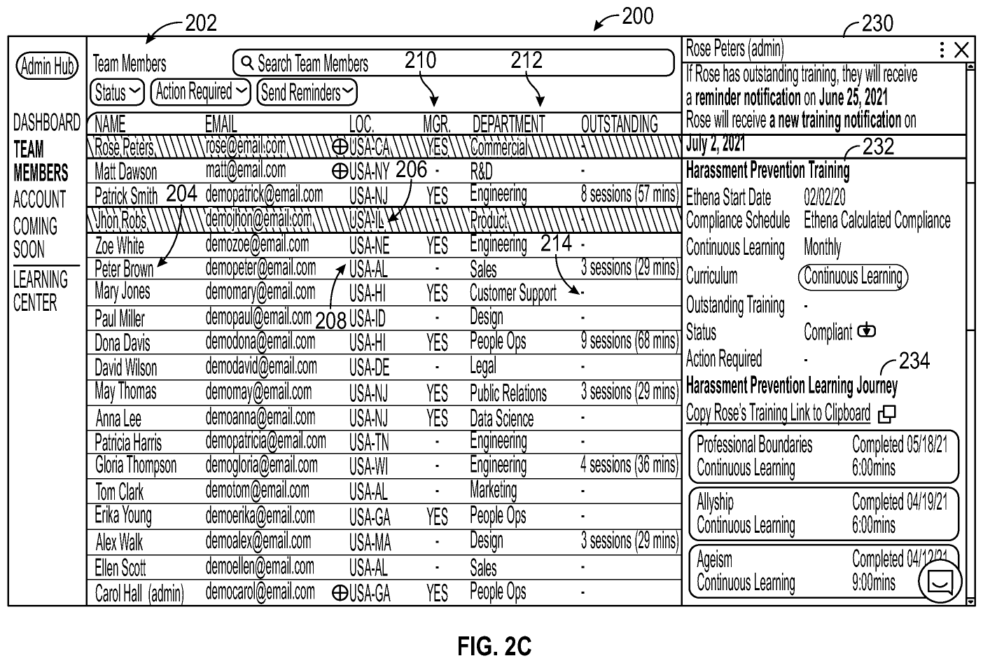

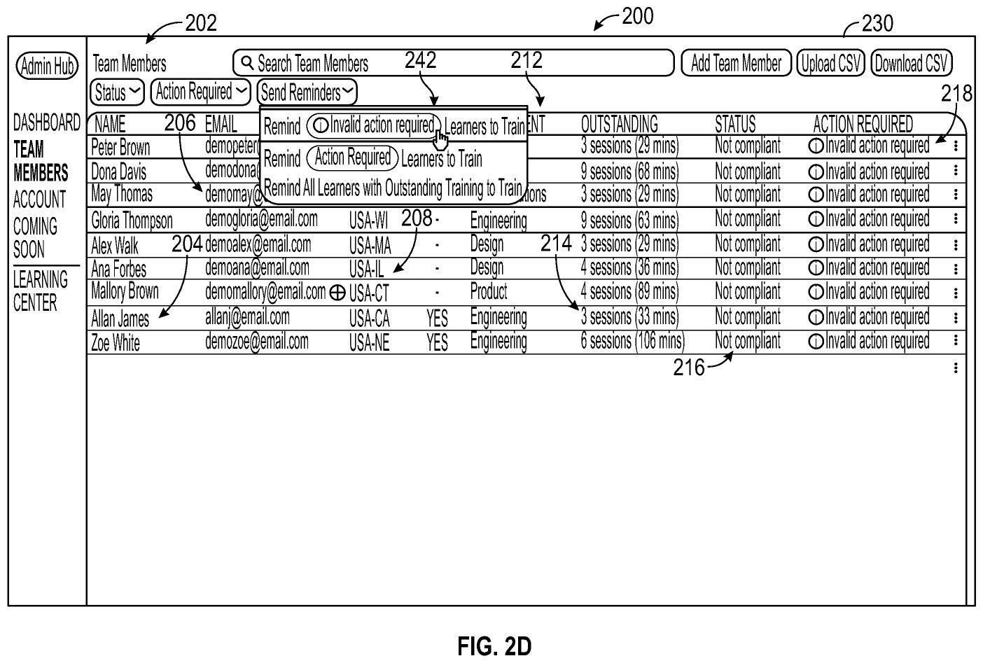

FIGS. 2A-2D illustrate exemplary user interfaces for compliance training, according to certain aspects of the present disclosure. Referring to FIG. 2A, a compliance engine interface 200 includes a list 204 of team members 202. Emails 206, locations 208, whether they are a manager 210 (e.g., management status), departments 212, outstanding training 214, compliance statuses 216, and notifications 218 (e.g., flags) are also listed for each team member 202 in the user interface 200.

According to aspects, the compliance status 216 may include whether each team member 202 is compliant, not compliant, a new learner, in a new state, a new manager, inactive, and/or terminated. According to aspects, the notifications 218 may include indications of no action required (e.g., learner expected to be compliant for at least the next three months, even if they were to completely ignore their training), action required (e.g., learner would fall out of compliance in three months if they were to completely ignore their training), immediate action required (e.g., learner is out of compliance), and/or on leave (e.g., training will continue to accumulate for learner to address upon their return).

Referring to FIG. 2B, a learning status 222 may be shown by hovering over a compliance status 216. For example, the learning status 222 may show that the team member 202 is a new learner, a transitioning learner, or a normal learner.

Referring to FIG. 2C, training details 230 may be viewed for each team member 202. For example, the training details 230 may include details regarding an individual training session 232, which may be part of a larger training journey 234. Referring to FIG. 2D, reminders 242 may be generated and sent to the team members 202 based on an urgency of a compliance status 216.

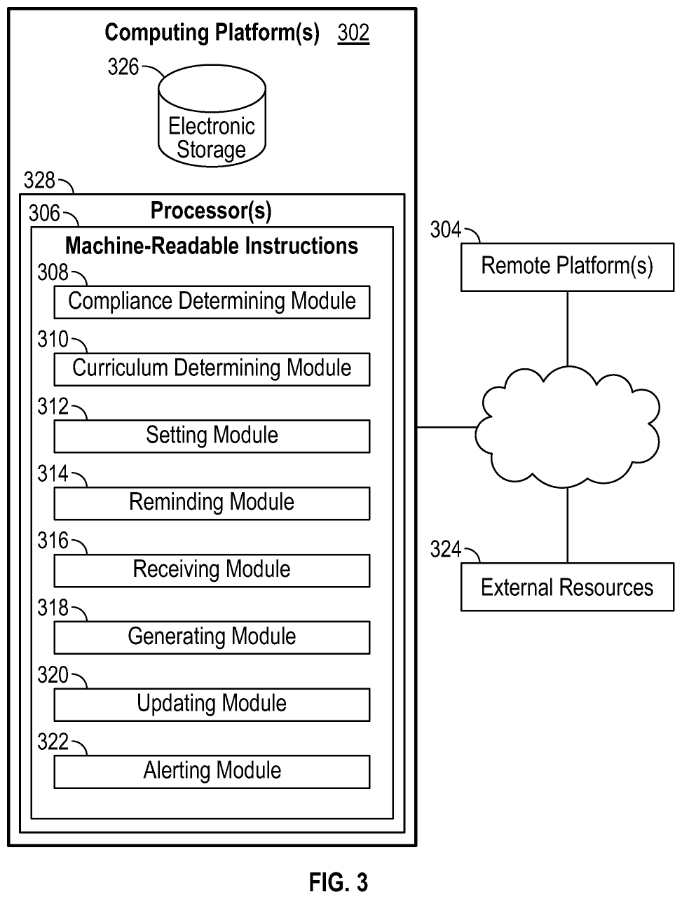

FIG. 3 illustrates a system 300 configured for compliance training, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 (e.g., the compliance engine) may be configured by machine-readable instructions 306. Machine-readable instructions 306 may include one or more instruction modules. The instruction modules may include computer program modules. The instruction modules may include one or more of compliance determining module 308, curriculum determining module 310, setting module 312, reminding module 314, receiving module 316, generating module 318, updating module 320, and/or alerting module 322, and/or other instruction modules.

Compliance determining module 308 may be configured to determine a compliance status of a user.

Curriculum determining module 310 may be configured to determine a curriculum for the user based at least in part on the determined compliance status of the user, the curriculum comprising a series of nudges.

Setting module 312 may be configured to set a deadline for completion of the curriculum.

Reminding module 314 may be configured to send reminders to the user regarding completion of the curriculum.

Receiving module 316 may be configured to receive confirmation of completion of the curriculum.

Generating module 318 may be configured to generate a compliance certificate for the user.

Updating module 320 may be configured to update the compliance status of the user based on completion of the curriculum.

Alerting module 322 may be configured to send an alert to the user regarding non-compliance (e.g., the user is not compliant).

In some implementations, computing platform(s) 302, remote platform(s) 304, and/or external resources 324 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 324 may be operatively linked via some other communication media.

A given remote platform 304 may include one or more processors configured to execute computer program modules. The computer program modules may be configured to enable an expert or user associated with the given remote platform 304 to interface with system 300 and/or external resources 324, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 324 may include sources of information outside of system 300, external entities participating with system 300, and/or other resources. In some implementations, some or all of the functionality attributed herein to external resources 324 may be provided by resources included in system 300.

Computing platform(s) 302 may include electronic storage 326, one or more processors 328, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 326 may comprise non-transitory storage media that electronically stores information. The electronic storage media of electronic storage 326 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 326 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 326 may include one or more virtual storage resources (e.g., cloud storage, a virtual private network, and/or other virtual storage resources). Electronic storage 326 may store software algorithms, information determined by processor(s) 328, information received from computing platform(s) 302, information received from remote platform(s) 304, and/or other information that enables computing platform(s) 302 to function as described herein.

Processor(s) 328 may be configured to provide information processing capabilities in computing platform(s) 302. As such, processor(s) 328 may include one or more of a digital processor, an analog processor, a digital circuit designed to process information, an analog circuit designed to process information, a state machine, and/or other mechanisms for electronically processing information. Although processor(s) 328 is shown in FIG. 3 as a single entity, this is for illustrative purposes only. In some implementations, processor(s) 328 may include a plurality of processing units. These processing units may be physically located within the same device, or processor(s) 328 may represent processing functionality of a plurality of devices operating in coordination. Processor(s) 328 may be configured to execute modules 308, 310, 312, 314, 316, 318, 320, and/or 322, and/or other modules. Processor(s) 328 may be configured to execute modules 308, 310, 312, 314, 316, 318, 320, and/or 322, and/or other modules by software, hardware, firmware, some combination of software, hardware, and/or firmware, and/or other mechanisms for configuring processing capabilities on processor(s) 328. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, and/or 322 are illustrated in FIG. 3 as being implemented within a single processing unit, in implementations in which processor(s) 328 includes multiple processing units, one or more of modules 308, 310, 312, 314, 316, 318, 320, and/or 322 may be implemented remotely from the other modules. The description of the functionality provided by the different modules 308, 310, 312, 314, 316, 318, 320, and/or 322 described below is for illustrative purposes, and is not intended to be limiting, as any of modules 308, 310, 312, 314, 316, 318, 320, and/or 322 may provide more or less functionality than is described. For example, one or more of modules 308, 310, 312, 314, 316, 318, 320, and/or 322 may be eliminated, and some or all of its functionality may be provided by other ones of modules 308, 310, 312, 314, 316, 318, 320, and/or 322. As another example, processor(s) 328 may be configured to execute one or more additional modules that may perform some or all of the functionality attributed below to one of modules 308, 310, 312, 314, 316, 318, 320, and/or 322.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

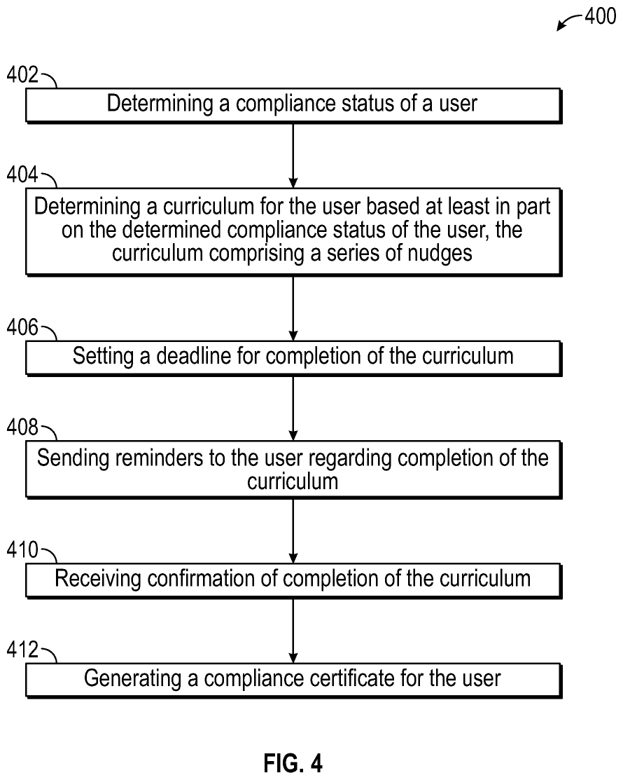

FIG. 4 illustrates an example flow diagram (e.g., process 400) for compliance training, according to certain aspects of the disclosure. For explanatory purposes, the example process 400 is described herein with reference to FIGS. 1-3. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1-3.

At step 402, a compliance status of a user is determined.

At step 404, a curriculum for the user is determined based at least in part on the determined compliance status of the user. The curriculum may include a series of nudges.

At step 406, a deadline for completion of the curriculum may be set. For example, the deadline for completion may include a drop dead date, such that if the learner fails to complete the training by a certain date, then the learner will fall out of compliance on that date. According to aspects, the deadline for completion may include a deadline for completion of individual nudges. For example, the deadline for completing an individual nudge may not be the same as the drop dead date. In this way, learners may be made aware of deadlines ahead of the drop dead date so that they do not unintentionally fall out of compliance.

At step 408, reminders may be sent to the user regarding completion of the curriculum.

At step 410, confirmation of completion of the curriculum is received.

At step 412, a compliance certificate is generated for the user.

For example, as described above in relation to FIGS. 1-3, at step 402, a compliance status (e.g., status 122, status 216) of a user (e.g., team member 202) is determined. At step 404, a curriculum (e.g., training details 230) for the user is determined based at least in part on the determined compliance status of the user. The curriculum may include a series of nudges. At step 406, a deadline for completion of the curriculum may be set (e.g., through setting module 312). At step 408, reminders (e.g., reminders 242) may be sent to the user regarding completion of the curriculum. At step 410, confirmation of completion of the curriculum is received (e.g., through receiving module 316). At step 412, a compliance certificate is generated for the user (e.g., through generating module 318).

According to an aspect, the compliance status is based on at least one of a date of onboarding of the user, a location of the user, a manager status of the user, and/or previous employment of the user.

According to an aspect, the curriculum comprises at least one of core curriculum, continuous learning, and/or refresher content.

According to an aspect, the process 400 may further include updating the compliance status of the user based on completion of the curriculum.

According to an aspect, the process 400 may further include sending an alert to the user regarding non-compliance. According to an aspect, at least one alert is sent at least a month before the deadline.

According to an aspect, the emotion may include at least one of happy, sad, angry, afraid, or motivated.

According to an aspect, the process 400 may further include generating curriculum content based on at least one of a completion rate and/or completion rating of the user.

According to an aspect, the curriculum comprises visual and/or audio content.

According to an aspect, the process 400 may further include sending the compliance certificate to a jurisdiction of the user.

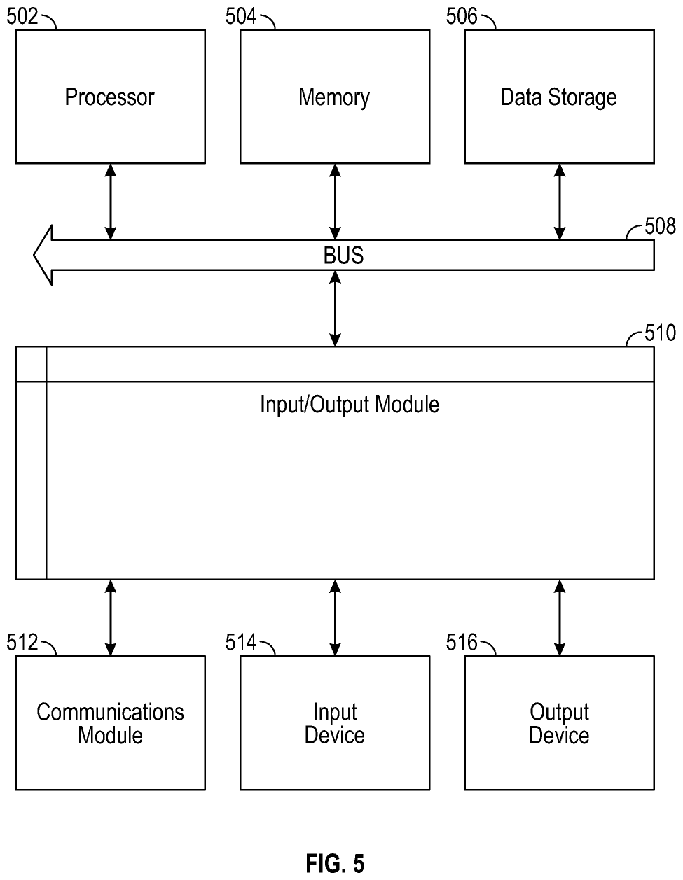

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads data, information may be read from the data and stored in a memory device, such as the memory 504. Additionally, data from the memory 504 servers accessed via a network, the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for compliance training, comprising:
determining a compliance status of a user;
determining a curriculum for the user based at least in part on the determined compliance status of the user, the curriculum comprising a series of nudges;
setting a deadline for completion of the curriculum;
sending reminders to the user regarding completion of the curriculum;
receiving confirmation of completion of the curriculum; and
generating a compliance certificate for the user.

2. The computer-implemented method of claim 1, wherein the compliance status is based on at least one of a date of onboarding of the user, a location of the user, and/or a manager status of the user.

3. The computer-implemented method of claim 1, wherein the curriculum comprises at least one of core curriculum, continuous learning, and/or refresher content.

4. The computer-implemented method of claim 1, further comprising:
updating the compliance status of the user based on completion of the curriculum.

5. The computer-implemented method of claim 1, further comprising:
sending an alert to the user regarding non-compliance.

6. The computer-implemented method of claim 5, wherein at least one alert is sent at least a month before the deadline.

7. The computer-implemented method of claim 1, further comprising:
generating curriculum content based on at least one of a completion rate and/or completion rating of the user.

8. The computer-implemented method of claim 1, wherein the curriculum comprises visual and/or audio content.

9. The computer-implemented method of claim 1, further comprising:
sending the compliance certificate to a jurisdiction of the user.

10. A system for compliance training, comprising:
a processor; and
a memory comprising instructions stored thereon, which when executed by the processor, causes the processor to perform:
determining a compliance status of a user;
determining a curriculum for the user based at least in part on the determined compliance status of the user, the curriculum comprising a series of nudges;
setting a deadline for completion of the curriculum;
sending reminders to the user regarding completion of the curriculum;
receiving confirmation of completion of the curriculum; and
generating a compliance certificate for the user.

11. The system of claim 10, wherein the compliance status is based on at least one of a date of onboarding of the user, a location of the user, and/or a manager status of the user.

12. The system of claim 10, wherein the curriculum comprises at least one of core curriculum, continuous learning, and/or refresher content.

13. The system of claim 10, further comprising stored sequences of instructions, which when executed by the processor, cause the processor to perform:
updating the compliance status of the user based on completion of the curriculum.

14. The system of claim 10, further comprising stored sequences of instructions, which when executed by the processor, cause the processor to perform:
sending an alert to the user regarding non-compliance.

15. The system of claim 14, wherein at least one alert is sent at least a month before the deadline.

16. The system of claim 10, further comprising stored sequences of instructions, which when executed by the processor, cause the processor to perform:
generating curriculum content based on at least one of a completion rate and/or completion rating of the user.

17. The system of claim 10, wherein the curriculum comprises visual and/or audio content.

18. The system of claim 10, further comprising stored sequences of instructions, which when executed by the processor, cause the processor to perform:
sending the compliance certificate to a jurisdiction of the user.

19. A non-transitory computer-readable storage medium comprising instructions stored thereon, which when executed by one or more processors, cause the one or more processors to perform operations for compliance training, the operations comprising:
determining a compliance status of a user;
determining a curriculum for the user based at least in part on the determined compliance status of the user, the curriculum comprising a series of nudges;
setting a deadline for completion of the curriculum;
sending reminders to the user regarding completion of the curriculum;
receiving confirmation of completion of the curriculum; and
generating a compliance certificate for the user.

20. The non-transitory computer-readable storage medium of claim 18, wherein the compliance status is based on at least one of a date of onboarding of the user, a location of the user, a manager status of the user, and/or previous employment of the user.
